(19) United States
(12) Patent Application Publication
(10) Pub. No.: US 2016/0272882 A1
(43) Pub. Date: Sep. 22, 2016

(54) Mineral-Encapsulated Tracers

(71) Applicant: INSTITUTT FOR ENERGITEKNIKK, Kjeller (NO)

(72) Inventors: Helge Stray, Hagan (NO); Jan Kihle, Skedsmokorset (NO)

(73) Assignee: INSTITUTT FOR ENERGITEKNIKK, Kjeller (NO)

(21) Appl. No.: 14/392,267

(22) PCT Filed: Jun. 24, 2014
(86) PCT No.: PCT/EP2014/063314

§ 371 Date: Dec. 24, 2015

(30) Foreign Application Priority Data
Jun. 24, 2013 (GB) 1311202.4
Jun. 24, 2013 (NO) 20130876

(51) Int. Cl. C09K 8/92; E21B 47/10; C09K 8/536

(52) U.S. Cl. CPC C09K 8/92; C09K 8/536; E21B 47/1015; E21B 43/26

(57) ABSTRACT

The invention provides controlled-release compositions comprising at least one encapsulating compound and at least one tracer and/or oil-field chemical, wherein the encapsulating compound is in the form of synthetic crystals having inclusions, and wherein said tracer and/or oil-field chemical is encapsulated within said inclusions. The invention further provides methods for the use of such composition including in tracking the flow, pH and/or salinity of at least one fluid within a geothermal reservoir or a reservoir for petroleum production, as well as in monitoring the integrity of cap and other barriers to fluid flow within the reservoir. Methods for the formation of such compositions are also provided.

### FIELD OF THE INVENTION

This invention relates to the utilization of synthetic mineral crystals containing tracers or other chemicals as fluid inclusions or in other ways included in the crystal framework. The crystals can be applied as sources of tracers in connection with investigations of fluid flows in petroleum reservoirs, in geothermal reservoirs or in industrial processes. The tracers are released by dissolution of the synthetic crystals or by diffusion. The crystals can also be applied as carriers for a number of other chemicals like oil field chemicals in connection with oil production and exploration.

### BACKGROUND OF THE INVENTION

Tracer technology is used extensively in oil and gas exploration and recovery, and both radioactive and non-radioactive tracers that can be measured at low concentrations are applied. Tracers may be injected as pulses in well-to-well studies for measuring flow paths and velocities. Tracer sources may also be placed in oil or gas production wells to monitor in-flow from the surrounding formation. For in-flow monitoring studies the tracers may be encapsulated in a polymer which is placed along the external surface of the production tube at different locations before completion of the well as described in U.S. Pat. No. 6,645,769. The tracers can be attached to or encapsulated in polymers or in different types of particles, and the release of the tracers can be made dependent on type of fluid passing (oil or water), of chemical properties of the fluid (for instance pH or salinity) or for example of temperature.

Hydraulic fracturing is frequently used for stimulating gas or oil production from petroleum reservoirs, and is particularly applied in connection with gas production from shale formations. A viscous fluid is pumped at high pressure into defined sections of the well, usually followed by ceramic spherical particles (proppants) to prevent the fractures from collapsing when production is resumed. The placement of tracer release particles in fractures located at different zones and with different tracers at each location in order to make identification of flow paths possible is described in several patents/publications (e.g., SPE 36675, U.S. Pat. No. 3,987,850 and WO 2010/140032 A2).

One limitation when a shell insoluble at preparation and injection conditions (for instance a polymer) is used to encapsulate a tracer material for injection or placement in the reservoir, is that the tracer will be released at a high rate at the beginning of the shell dissolution at reservoir conditions or upon being put in contact with the target chemicals, subsequently decreasing exponentially with time. Water tracers are usually applied as salts and the tracer salt in the surface layer will be dissolved rapidly and pores are formed in the polymer matrix, giving access to tracer salt encapsulated deeper inside the polymer matrix. The release rate will, however, be slower and slower due to longer diffusion time through the porous layer. This makes the release rate at a given time of exposure a complex function of many parameters and is thus difficult to estimate. The water tracer salts applied are generally very soluble in water, and flow rate of the passing water will have negligible effects on the release rate of the tracer since the tracer salts will not reach saturation. Also if the tracer is covalently bonded or bonded by ionic interactions to the polymer, the release rate will be high at the beginning and decrease exponentially with time.

In hydraulic fracturing tracer studies, particles with encapsulated tracers can be pumped into the fractures together with or followed by ceramic proppants. One disadvantage of tracers being encapsulated in polymer particles or adsorbed on particles which are encapsulated by a polymer layer (core-shell type particles), is that the particles may be crushed during the process of pumping the fracturing fluid containing proppants into the fractures. This will lead to premature release of tracer and reduction of the tracer release period available for tracer monitoring. The release of tracer from a solid polymer particle will be high at the start and decrease exponentially if the release is based on dissolution of the tracer from the matrix and also if the tracer release is based on diffusion of volatile compounds through a polymer matrix.

In view of the above, it would be a considerable advantage to provide compositions which can release tracers or other chemicals into a subterranean reservoir in a more controlled and predictable manner. It would be a further advantage if such compositions were physically robust (e.g. to pressure and/or temperature) so that they could be used in situations such as fracturing and/or in geothermal reservoirs where the use of conventional polymer-based tracer release agents is undesirable or impossible on practical grounds.

### SUMMARY OF THE INVENTION

The present inventors have now established that by entrapment of appropriate tracers or other chemicals in inclusions within synthetic crystals, a composition can be generated which can address some or all of the above issues.

In a first aspect, the invention therefore provides a controlled-release composition comprising at least one encapsulating compound and at least one tracer and/or oil-field chemical, wherein said encapsulating compound is in the form of synthetic crystals having inclusions, and wherein said tracer and/or oil-field chemical is encapsulated within said inclusions.

As used herein, “inclusion” is used to indicate any trapping or containment of material within the crystal structure of the encapsulating material. This may be in the form of discrete liquid and/or solid voids in the structure or integrated at a molecular level where the tracer compound or oil-field chemical is locked into the crystal structure.

The term “fluid inclusions” as used herein takes its usual meaning in the art, which is to say that by that term we refer to microscopic bubbles of liquid and/or gas that are trapped within crystalline minerals. As minerals often form from a liquid or aqueous medium, tiny blebs of that liquid can become trapped within the crystal structure or in healed fractures within a crystal.

FIG. 9 below shows a micrograph demonstrating multiple fluid inclusions consisting of a vapour bubble, brine (salty water) and oil droplets hosted in a synthetic mineral crystal of PotasssiumDiHydrogenPhosphate. The sample was prepared as a doubly polished thick-section plate preparate (see Geochimica et Cosmochimica Acta, Vol. 58, No. 3, pp. 1193-1202, 1994)

In all cases, however, the tracer or chemical is included such that it is trapped within the crystal structure of the encapsulating material and is not simply absorbed, such that the material cannot readily diffuse out of the structure. Rather the tracer or chemical is contained such that it is released primarily upon dissolution of the encapsulating crystal. Typically not more and preferably less than 50%, more preferably not more than 20% of the tracer or oil-field chemical will be released prior by diffusion through the crystal structure during the dissolution of the crystal. This may be tested, for example in a solvent in which the encapsulating material does not dissolve.

The controlled-release formulation of the present invention will generally be formed of any of the types of crystal structures indicated herein, some of which are naturally occurring but for the purposes of the present invention are described as “synthetic” since they are generated and/or modified so as to entrap or encapsulate at least one tracer and/or oil-field chemical therein.

The controlled-release compositions of the invention are useful in various methods, particularly when applied to subterranean (which may also be taken as under the sea bed) reservoirs. Such reservoirs typically produce oil and/or gas, but may equally be geothermal reservoirs producing hot water and/or steam. In a second embodiment the invention therefore provides a method for tracking the flow, pH and/or salinity of at least one fluid within a geothermal reservoir or a reservoir for petroleum production, said method comprising applying at least one controlled-release composition as defined in any preceding claim to at least one known position in said reservoir and monitoring for the absence, presence and/or concentration of at least one of said tracers in fluid produced from at least one well in said reservoir. The compositions of the invention may be applied to a reservoir in one or more of many ways. Thus, the composition may be applied within completion equipment such as sand filter sleeve, may be placed into fractures or in the annulus and/or may be placed on the surface of tubulars. In one preferred embodiment, the composition may be put in place during the process of hydraulic fracturing, for example in the fracturing of shale deposits. This may be, for example, by including the compositions of the invention in the fracturing fluid and/or with the proppants.

Other applications of the compositions of the present invention will be evident to the skilled worker and include, for example, a method for monitoring and/or validating the integrity of an isolation plug in a petroleum reservoir or geothermal reservoir, said method comprising applying at least one controlled-release composition as claimed in any of claims 1 to 11 on the downhole side (e.g. upstream) of said isolation plug and monitoring for the tracer comprised in the controlled-release composition in the produced fluid from said reservoir. Thus, this and each application of the compositions forms a further embodiment of the invention.

There are other applications. Monitoring and/or validating reservoir layers separation in a multi-layer reservoir is one, for example after an operation of stimulation or injection of chemicals to provide a flow barrier, such as in US20110277996. Monitoring geometry of a fracture, such as described in WO2010011402 is another. Monitoring and tracking backflow of proppants, such as described in WO2005103446 is another. Assessing recovery of material injected in a subterranean formation such as in WO2002095159 is another. Assessing the volume of fluid injection in a reservoir stimulation is yet another, such as described in WO2011141875.

### DETAILED DESCRIPTION OF THE INVENTION

In the present invention synthetic mineral crystals (encapsulating compounds) are used as bearers of inclusions of tracer material or other substances like oil field chemicals. Broadly, the invention can be used in many applications where a predictable release of chemicals is required. The release can be based on dissolution of the encapsulating mineral crystals in water. Suitable chemicals for encapsulation include water tracers, oil tracers or gas tracers or other chemicals that are added in order to improve performance of the production or reduce unwanted reactions or precipitations. Many such chemicals will be well known in the relevant field.

### Tracer In-Flow Monitoring or Introduction of Production Chemicals in Different Zones Along a Production Tube

The controlled-release composition in the form of crystals with inclusions containing tracers or oil-field chemicals may be used as a plurality of compositions, each containing different tracers. These may be used in studies of water in-flow in reservoirs, such as petroleum reservoir production wells. In suitable methods of the invention, two or more controlled-release compositions of the invention are used. This may involve the use of, for example 2-10 different controlled-release compounds, such as 2-5. Two, three, four or five different controlled release compositions used together form a preferred embodiment.

In one embodiment, the compositions comprising crystals containing defined tracers are placed at specific locations in the reservoir along the production tube enabling identification of zones where water in-flow occurs. Each different composition is typically applied at a different known location within the reservoir (e.g. along the well) and produced fluid at one or more location(s) of said reservoir is monitored for the presence of the tracers. These locations can be different layers of the same reservoir, allowing for monitoring of layer separation or inter-layer flow. Alternatively or in combination, the locations may be different zones of the same layer. In an alternative embodiment, more than one composition can be applied at a single location but in such cases the compositions will typically include two or more encapsulating compounds with different dissolution behaviour and with different tracers or other compounds. Thus the release of tracers or other compounds may be used to monitor or react to changes in conditions such as pH, salinity, pressure and/or temperature within the reservoir.

In a further embodiment, the invention provides a method for assessing the structure of a fracture in a subterranean reservoir, the method comprising applying two or more compositions of the present invention to the reservoir (especially to the fracture) wherein the two or more compositions comprise different tracers and different average particle sizes. Since the distance that a composition will travel into a fracture is typically related to the particle size, the method typically involves monitoring for the at least two different tracers (which are comprised in the at least two different compositions) in at least one fluid stream produced from said reservoir. The absence, presence and/or concentration of the two or more tracers in the at least one fluid stream can then be related to the structure of the fracture and the average particle sizes of the compositions.

### Compounds and Compositions

The compositions of the present invention (which are applicable to all aspects of the invention) are “controlled release” in that the tracers or oil-field chemicals included in the compositions are not released into the fluid instantaneously, but rather are released over a period of time, depending upon the flow and/or conditions of the reservoir. Specifically, 50% of the tracer or other chemical may be released over a period of 1 hour to 10 years, more commonly 1 hour to 5 years, preferably over a period of 1 day to 24 months (such as 1 day to 3 weeks, 1 week to 3 or 6 months or 1 month to 24 months), following (and especially during) contact with fluids within the reservoir. Contact with fluids within the reservoir may occur immediately upon placement of the compositions in the reservoir environment. However, that contact may also occur later if the composition is contained, for example within a device that can open the composition to the fluid environment of the reservoir at a later date or time upon for example meeting the targeted conditions of pH , temperature, or salinity . Similarly, if a composition is within a device that can intermittently place the composition in contact with fluids in the reservoir environment then this time will be taken to be the duration for which that contact was maintained.

In the case of compositions used to monitor the integrity of valves, caps or similar blockages of flow, the duration of contact may be longer because the compositions may be placed in a position where fluid is present but not flowing. In one embodiment, the compositions therefore release 50% of their tracer or oil-field chemical(s) in the above time periods of contact with flowing fluid within the reservoir. In some appropriate uses and methods, however, the contacting may be for longer periods, such as 1 month to 10 years, preferably 3 months to 5 years. Such methods may in one embodiment include methods for monitoring the integrity of caps, valves or similar items. Conversely, where the composition is used directly in continuous contact with the fluids of the reservoir then typical periods are preferably shorter, such as 1 day to 3 years, preferably 1 week to 24 months, or 1 week to 12 months.

Different types of minerals can be used to form crystals with a wide range of solubility properties. At a constant salinity, pH, temperature and pressure the solubility of the crystals will be predictable and will be dependent primarily on flow-rate. When the concentration of the tracer trapped in the crystals is known, the release rate of tracer at given conditions will be possible to estimate. Provided the salinity, pH, temperature and pressure is in the same range along the production tube, the release rate of tracers from different zones of the wellbore will be depending primarily on flow rate if the same encapsulating compound (crystal type) is used for each tracer. Thus the measured concentration of each tracer in the produced water may be related linearly or in another predictable way to the relative amount of inflow from each zone. The solubility of the crystals may also be made dependent of pH or salinity, making increased release rate of tracer or other chemicals possible at significant changes in the pH-value or salinity. Certain other factors, such as temperature and pressure, may also be monitored but pH and/or salinity form preferred parameters for controlling release.

In any appropriate aspect of the present invention, such as when applied to in-flow tracer studies, the compositions of the invention can be consolidated into rods or bars that can be placed in the reservoir, for example under the sand screens. Consolidation of crystals can be performed by filling a suitable mould with the crystals and slowly pumping through a saturated solution of the same salt that the crystals consist of. Precipitation from this saturated fluid will act as a bonding agent making the tracer crystals stick together. The resulting rod, bar or other solid shape will resemble the crystals in a lump of sugar, thus producing large bars or pieces of crystal, which may be formed in a shape appropriate for application and/or may be easily manipulated into place.

In one preferred embodiment of the invention, the encapsulating compound(s) utilised in the various aspects of the invention are “sparingly soluble” or “low solubility” in water. Such solubility is typically in the range 10⁻¹ to 10⁻³ g/100 ml H₂O, preferably in range 10⁻² to 10⁻³, all measured at standard temperature and pressure conditions. Solubility and solubility measurement can be assessed by standard methods well known in the relevant art. Typical solubilities for example compounds useful in all aspects of the invention are, for example, BaSO₄: 10⁻⁴ to 10⁻³ g/100 ml H₂O and SrSO₄: 3*10⁻³ g/100 ml H₂O under STP conditions. Typically, Calcite has a solubility of 10⁻⁴ g/100 ml H₂O under STP.

Compounds of particular value as the “mineral crystals” of the present invention include, for example, any selected from sulphates, halogenides, silicates, molybdates, phosphates, wolframates (tungstates), carbonates, sulphides and oxides and mixtures thereof. Such salts may be of any metal cation or mixtures of metal cations. Example metal cations of value in the various embodiments of the present invention include cations of calcium, barium, strontium, lead, silver, magnesium, manganese, iron, titanium, zinc, aluminium and mixtures thereof. Particularly suitable examples include:

SULPHATES: (Me1Me2)ₓ(SO₄)_{y}, where Mel and Met are cations, preferably of Ba, Sr, Pb, Ca and X and Y are independently integers, typically in the range 1 to 10 (e.g. 1 to 5). Representative examples: Baryte, Celestite, Anglesite

HALOGENIDES: MeX, where Me is cation of preferably Ag, Ca or Pb and X is F, Cl, I or Br. Representative examples: fluorite, Chlorargyrite, Bromargyrite, Cotunnite.

SILICATES: e.g., Cordierite, Zeolites . . .

MOLYBDATES: MeMoO₄where Me is cation of preferably Ca, Pb, Ba. Representative examples: Powellite, Wulfenite.

WOLFRAMATES: MeWO₄, where Me is cation of preferably Ca, Pb, Ba. Representative examples: Scheelite, Stolzite.

PHOSPHATES: Meₓ(PO₄)_{y}, where Me is cation of preferably Zn and Ca and X and Y are independently integers, typically in the range 1 to 10 (e.g. 1 to 5). Representative examples: Hopeite, Stoltzite, Tarbuttite.

CARBONATES: Meₓ(CO₃)_{y}, where Me is cations of preferably Ca, Mg, Mn, Fe and X and Y are independently integers, typically in the range 1 to 10 (e.g. 1 to 5). Representative examples: Calcite, Magnesite, Dolomite, Ankerite, Rhodochrosite

SULPHIDES: MexSy, where Me is cations of preferably Fe, Ag and X and Y are independently integers, typically in the range 1 to 10 (e.g. 1 to 5). Representative examples: Marcasite, Pyrite, Argentite

OXIDES and HYDROXIDES: MeₓO_{y}H_{z}wherein Me is one or more cations of, for example, silicon, aluminium, magnesium, titanium, copper, beryllium, tin, zirconium, lead, iron, manganese and mixtures thereof, X and Y Z are independently integers, typically in the range 1 to 20 (e.g. 1 to 10 or 1 to 5) for x and Y and 0 or 1 for Z. Representative examples include single oxides: silica (e.g., Quartz), aluminium oxides (as Corundum), magnesium oxides (as Periclase) and complex oxides such as Spinel group minerals.

In order to maintain the stability desired for certain applications of the present invention, in one embodiment it is preferable that the crystalline encapsulating compound have no phase transition between STP and the conditions of the reservoir. Such conditions may typically be a pressure of up to 1 kilobar (e.g. 1 to 1000 bar), preferably 50-350 bar. Temperatures are typically 20 to 500° C., preferably 70-250° C.

The amount of tracer or oil-field chemical entrapped in the controlled-release compositions of the present invention will depend upon several factors. Specifically, the water-solubility of the compound/tracer, its value and ease of detection will be factors in deciding what concentration to use, as will the capacity of the encapsulating material to be crystallised into solid crystals having inclusions therein. A suitable range of tracer/chemical concentrations may be 0.1 μg/g of composition right up to around 50% by weight. Lower loadings will be most suitable for tracers. Oilfield chemicals may be required at higher loading levels. This will preferably be from 1 part per million (by weight) up to 25% by weight, more preferably around 1 to 5 000 ppm (such as 1 ppm to 500 ppm, especially for tracers) or around 1000 ppm to 5 wt% (especially for oilfield chemicals) Suitable tracers include any chemicals which are soluble in at least one fluid present in the reservoir and not naturally present. Such compounds include, for example, fluorinated compounds, fluorescent compounds and radioactive compounds. Examples include: halogenated (e.g. fluorinated or chlorinated) benzoic acids, sulfonic acids of naphthalene and other polyaromatic hydrocarbons (PAH), amino-naphthalene sulfonic acids and other amino- or hydroxyl-substituted PAH sulfonic acids, fluorescein and fluorescein derivatives.

Formation of synthetic crystals from sparingly soluble salts like BaSO₄ and SrSO₄, (Ba,Sr)SO₄or (Ba,Sr)CO₃ where polymerized silica gel is used as diffusion matrix has been reported in the literature (M. Prieto et al., Geochimica et Cosmochimica Acta, Vol. 61, No. 16, pp. 3383-3397 with references). By making crystals with different combinations of Ba and Sr in the crystal framework, the solubility properties of the crystals may be altered. Crystals of SrSO₄ have a solubility of 0.0135 g/100 ml water at 25° C. which is about 55 times more soluble than crystals of BaSO₄, and in brine solutions the difference is even larger since presence of alkali chlorides has a large effect on the solubility of SrSO₄. The hardness of SrSO₄ and BaSO₄ crystals is 3-3,5 on Mohs' scale, making the crystals able to withstand the physical stress when pumped with proppants into fractures at high pressure. In addition to crystals with water-soluble tracers, crystal inclusions of tracer-bearing (water-insoluble) organic fluids may also be made. The trapping of hydrocarbon fluid inclusions in synthetic crystals of KH₂PO₄ has been reported by J. Kihle and H. Johansen (Geochimica et Cosmochimica Acta, Vol. 58, No. 3, pp. 1193-1202, 1994). Depending on the conditions and time of crystallization, crystals with large variation in size can be produced, and the produced crystals can be sieved into different size fractions for different applications. Crystals can be made from a large number of sparingly soluble salts and can be tailored for special applications. For instance the solubility of crystals of different carbonates like CaCO₃, are highly dependent on pH, and this can be utilized to monitor changes in pH of passing fluids.

### Application of Invention in Tracer Deployment and Clean Out Valves and Plug Leak Detection Tools

Clean out valves or tracer deployment valves are time delay based devices that are integral part of the completion string. A chamber with tracer will be opened after a pre-set time and allows for dissolution tracer into the passing fluids. Functioning of the valve can thus be verified if the tracer is detected in the produced fluids. The tracer may be dissolved in a fluid and placed in the tracer chamber in advance, but preferably the tracer should be mixed into a polymer or some other matrix to allow for release over a longer time period. For such applications synthetic crystals with tracers can be applied in the form of bars with crystals sticking together. The advantage with synthetic crystals compared to tracer encapsulated in polymers is that the release rate will be more even. Also in plug leak detection tools synthetic crystals can be applied. If a chamber with tracer crystals is placed upstream (on the downhole side of the plug) the isolation plug, a leakage from the plug will be detected if the tracer is found in the produced fluids.

### Application of the Invention to Investigations of Fractures

The present invention provides a process of making observations of fluid movements in fractures in oil or gas wells. A plurality of sets of crystals containing different tracers are conveyed down the wellbore and allowed to enter fractures at a first location. The first set of crystals containing a first set of tracers will dissolve gradually in the water present in the reservoir or in the fracturing fluid, and the tracer which may be a water tracer and/or an oil or gas tracer is released. A second set of tracer crystals can be conveyed from the surface to a second location and allowed to enter fractures in the second location. The number of sets of tracer crystals may be greater than two, thus enabling tracer crystals to enter fractures in more than two locations. The tracers are distinguishable from each other so that detection of a tracer substance in the produced fluid will allow identification of the crystals and the location where they were placed.

### Application of the Invention to Release of Oilfield Chemicals

The present invention also provides a process for release of oil field chemicals from near-well locations in oil or gas production wells. Crystals carrying oil field chemicals can be conveyed down the well bore and placed in the reservoir. For example, crystals can be allowed to enter fractures at dedicated locations. The crystals may gradually be dissolved releasing oil field chemicals. The oil field chemicals can be, but are not limited to, scale inhibitors, corrosion inhibitors, wax inhibitors, hydrate inhibitors, surfactants, antifoaming agents, biocides, demulsifiers, hydrogen sulfide or oxygen scavengers, asphaltene inhibitors, and nano particles used for their tracing or Enhanced Oil Recovery improving characteristics.

### Application of Invention in Geothermal Reservoirs

The present invention also provides a process for release of tracers to monitor fluid movements and velocities in geothermal reservoirs. The crystals can be conveyed to fractures at specific locations allowing identification of water pathways in the reservoir. Tracer crystals can here be used in near-well applications, or interwell applications.

### General Advantages of Application of Invention

The advantages of applying crystals with inclusions of tracers or other chemicals compared to other techniques are first of all that the release of the tracer or other chemicals can be spread over a longer time period, be more constant throughout the entire lifetime of the source of tracer or other chemicals, and that the release rate is more easy to estimate. Unlike other applications where tracer particles with low physical strength are used, crystals can be applied that are able to withstand the hard physical stress that is encountered in fracturing processes. Another property of the synthetic crystals is that the release rate will be much more dependent of flow rate of the passing water. This property will be of importance for calculation of in-flow from different zones in reservoirs. In addition the crystals can be produced from salts that are normally present in formation water and dissolution of the crystals will therefore not result in any significant impact on the environment.

In an experiment performed in the inventors' laboratory, crystals of Celestite (SrSO₄) containing 2.5 pg carboxyfluorescein/g were produced. By increasing the concentration of the tracer in the solution during crystallization, the amount of trapped tracer can be increased. The carboxyfluorescein tracer can be detected using high performance liquid chromatography with laser induced fluorescence detection at concentration lower than 1 parts per trillion. Depending on flow rate and total water production in a well it is estimated that only a few kg of crystals with suitable solubility containing 10-30 μg tracer/g will be suitable for in-flow measurements.

The apparatus of FIG. 1 illustrates an apparatus suitable for the methods of the present invention. This figure illustrates the use of a tube, such as a glass U-tube (1) having therein a first reagent, such as a first salt (2) and a second reagent, such as a second salt (3), these reagents being separated by a diffusion (crystalisation) region (4) which contains a dissolved tracer or chemical and will typically be formed as a gel. After a reaction period indicated by the “Time” arrow, reaction of reagents (2) and (3) in the crystallisation zone (4) results in the formation of crystals (5) of encapsulating material. As crystals form, further material diffuses from reagents (2) and (3) as shown. The crystals (5) contain inclusions (6) which contain tracer (7) in accordance with the invention as described herein.

The production of crystals can easily be increased from laboratory small scale to industrial large scale. Applying diffusion tubes with larger diameters can simply do this. The chemicals required are relatively inexpensive and should not be of any threat to the environment when applied correctly. A number of different tracers could be applied, like fluorinated benzoic acids, naphthalene sulfonic acids, amino-naphthalene sulfonic acids, fluorescein and fluorescein derivatives. The tracers are usually more expensive than the other chemicals applied and should therefore be recovered in the production process.

To avoid the tracers mixed into the gel to diffuse into the reactant solutions, nano-filters that let the smaller reactant ions diffuse into the gel while the larger tracer-molecules are held back can be placed on each side of the gel. This will prevent the concentration of tracer in the gel from being reduced during the crystallization process so that more inclusion of tracer in the crystals may be obtained. This method forms a further aspect of the present invention. Such a method comprises a method of production of a controlled-release composition (as described in any embodiment herein) by means contacting a first and second salt in a gel crystallisation zone containing at least one tracer as described herein, said crystallisation zone being placed between two semi-permeable membranes which permit passage of said first and second salts but prevent or impede passage of said at least one tracer. Suitable membranes are well known in the art and include size-exclusion membranes and reverse osmosis membranes.

Another possibility for reducing diffusion of tracer out of the gel is to replace the reactant solutions with a layer of gel containing the reactant ions on each side of the tracer gel. This will both limit diffusion speed, and allow a smaller volume of diffusion. This method forms a further aspect of the present invention. Such a method comprises a method of production of a controlled-release composition (as described in any embodiment herein) by means of contacting a first and second salt in a gel crystallisation zone containing at least one tracer, said crystallisation zone being placed between a first reactant zone containing said first salt and a second reactant zone containing said second salt, wherein each of the first and second reactant zones is in the form of a gel. Such a method may be implemented using an apparatus as illustrated schematically in FIG. 1, wherein reagents (2) and (3) as well as crystallisation region (4) are in the form of a gel.

Similarly, the apparatus of FIG. 8 illustrates an apparatus suitable for the methods of the present invention. This figure illustrates the use of a container, such as a glass beaker (8) having therein a first reagent, such as a first salt (2) and a second reagent, such as a second salt (3), these reagents being separated by a diffusion (crystalisation) region (4) which contains a dissolved tracer or chemical and will typically be formed as a gel. When using a container of this type, the first reagent (2) and/or the second reagent (3) are typically formed as a gel (as described herein). As with the embodiment shown in FIG. 1, after a time, reaction of reagents (2) and (3) in the crystallisation zone (4) results in the formation of crystals (5) of encapsulating material. As crystals form, further material diffuses from reagents (2) and (3). The crystals formed in this embodiment are equivalent to those illustrated in the expanded portion of FIG. 1, in which crystals (5) contain inclusions (6) which contain tracer (7) in accordance with the invention as described herein.

In all suitable embodiments, reagents (2) and (3) may be separated from crystallisation zone (4) by means of at least one membrane. Such a membrane may be any suitable membrane including those described herein. Preferably such a membrane will serve to allow diffusion of the first and second reagents (e.g. first and second salts) from portions (2) and (3) but will prevent, reduce or limit diffusion of the tracer or oil-well chemical out from the crystallisation zone (4).

In each of the above aspects of the invention, the first and second salts, upon contact in solution precipitate crystals of an encapsulating compound (as described herein in any embodiment). It is preferable that such crystals of encapsulating compound have solid, gas or fluid inclusions, especially inclusions of said at least one tracer.

To generate suitable gels, Agar Agar and gelatin gels containing for instance CaCl2, SrCl2 or BaCl2 can be made by boiling up the Agar Agar powder or the gelatin sheets in a water solution of suitable strength (0.1-0.5M). After cooling a gel with sufficient hardness will be formed. If the same procedure is followed for Na2CO3, the gel solution will not harden. The Agar Agar powder or gelatin sheets can, however, be dissolved in boiling in water first and afterwards a more concentrated solution of Na2CO3 is mixed into the Agar Agar or gelatin solution to forma gel with the desired concentration of reactant. Production of similar gels made of sodium silicate is more difficult since the formation of silicate gels are more dependent on pH.

### BRIEF DESCRIPTION OF DRAWINGS

FIG. 1: diagrammatically illustrates the formation of synthetic crystals with tracers by diffusion of salt solutions through diffusion media containing tracer;

FIG. 2: photograph of a tracer bearing celestite crystal (SrSO4) with tracer occurring in the form of fluid inclusions and as tracer trapped within the crystal framework

FIG. 3: diagram showing typical release pattern of water tracer from a polymer matrix

FIG. 4: diagram showing release of tracer from celestite crystals normalized to flow rate

FIG. 5: photograph with normal and UV-light (366 nm) of barite crystals (BaSO₄) containing tracer showing fluorescent response from tracer

FIG. 6: photograph of CaCO₃ crystals containing 5(6)-carboxyfluorescein

FIG. 7: photograph of celestite crystals with liquid inclusions of the gas tracer PDEC

FIG. 8: Schematic diagram of crystals (such as CaCO₃ containing 5(6)-carboxyfluorescein) precipitating at the boundary of reacting fluids

FIG. 9: photograph/micrograph illustrating the inclusions as described herein, showing various phases enclosed within an encapsulating structure.

### DETAILED DESCRIPTION AND EXAMPLES OF PREPARATION

### Example 1

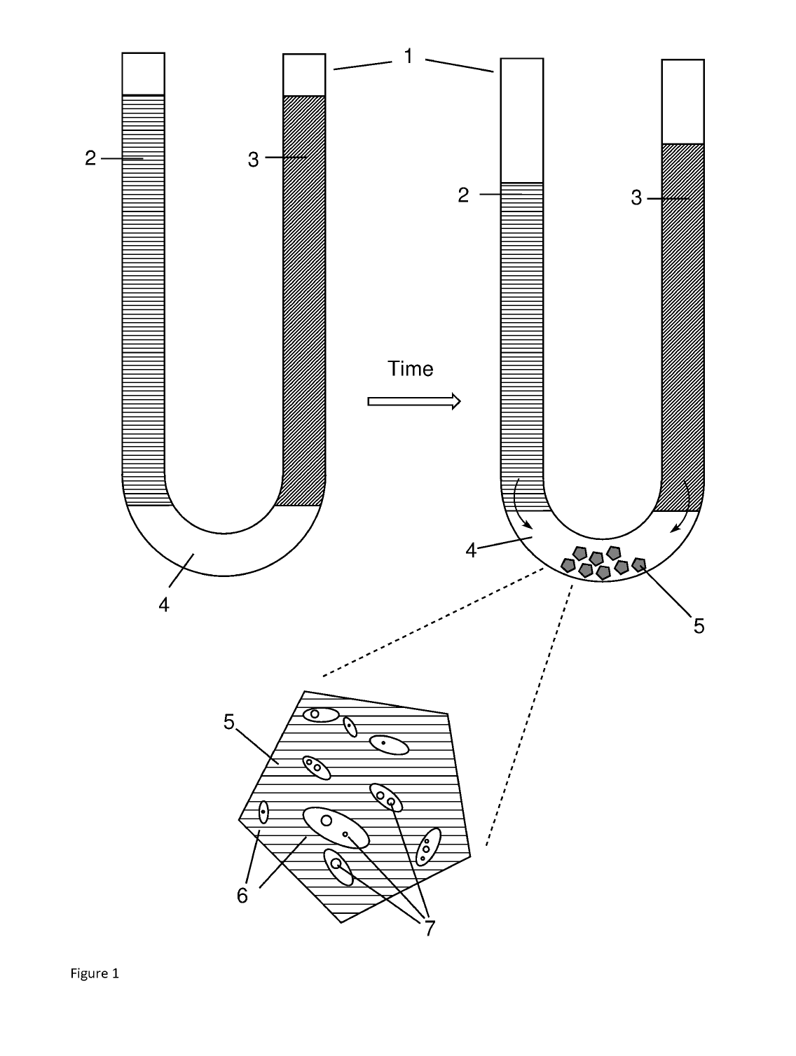

An apparatus suitable for the method of this Example is illustrated in FIG. 1A glass tube 150 mm long and with inner diameter 22 mm was filled with silica gel with density 1.02 g/ml polymerized at pH 5.5 with HCl. Reactant 1 as shown in FIG. 1 was 0.5 M SrCl₂ solution in water, and Reactant 2 was 0.5 M Na₂SO₄ and 0.01 M 5(6)-carboxyfluorescein. The tube containing the polymerized silica gel was immersed in a silicon oil bath with a temperature of 50+/−0.2° C. for 10 days. The silica gel containing the celestite crystals was transferred from the glass tube to a glass beaker and the silica gel was dissolved in diluted sodium hydroxide solution. The crystals were washed several times in water to remove silica gel particles and washed in ethanol before drying for one hour at 60° C. in a heating cabinet.

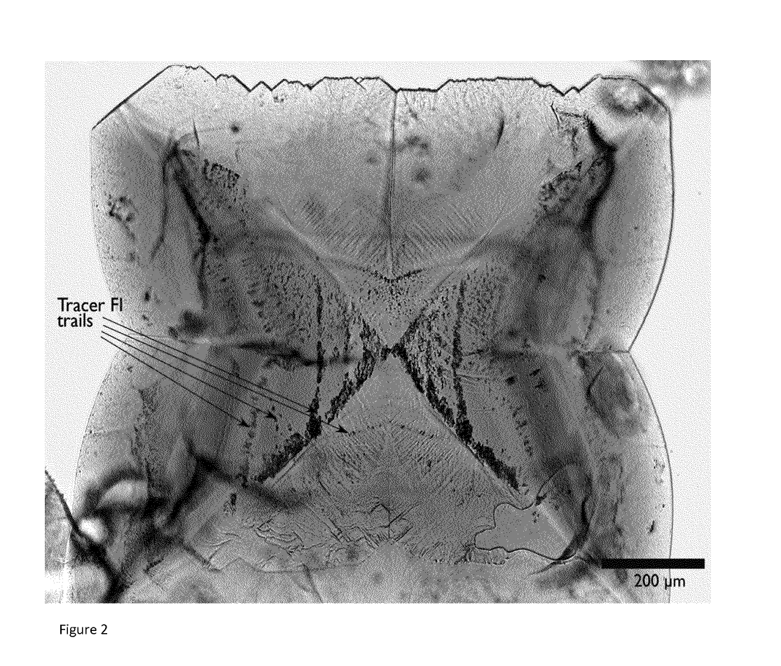

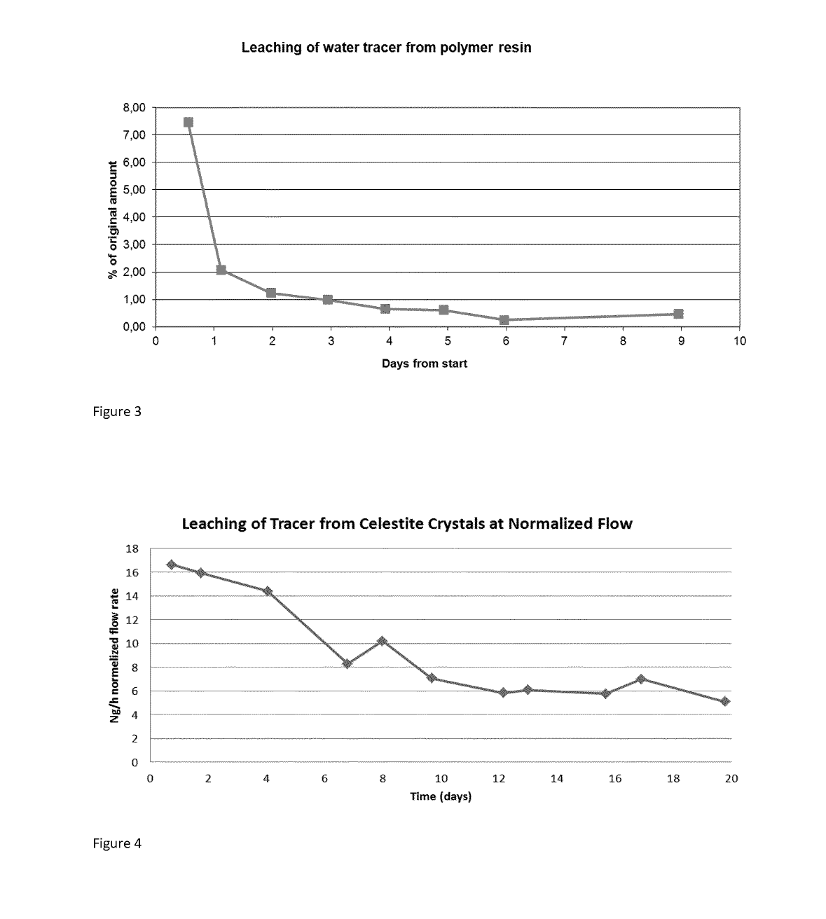

A photograph of one of the celestite crystals containing the fluorescent tracer both as fluid inclusions and with the tracer trapped within the crystal framework is shown in FIG. 2. 102 mg of the crystals were weighed out and transferred to a 50 mm×4.6 mm inner diameter stainless steel column with end couplings with 0.5 μm PEEK frits. A 20 cm fused silica tubing with inner diameter 20 μm was connected to the outlet of the column, and an artificial formation water solution containing 4% NaCl was pumped through the column at a flow rate of 0.01-0.005 ml/min. The column was kept in a heating cabinet at 100° C. and the back pressure was 50-100 bars depending on flow rate. The eluent was collected and the concentration of the dissolved tracer was analyzed in the collected fractions.

After 20 days the remaining crystals were removed from the column, washed in deionized water, dried and weighed. 87 mg of the original 102 mg crystals had been dissolved during the 20 days leaching period. By analyzing the tracer concentration in the collected fraction it was found that the mean concentration of tracer trapped in the dissolved crystals was 25 μg/g. As shown in FIG. 4 the normalized release rate of tracer was reduced by a factor less than 3 during the experiment.

### Example 2

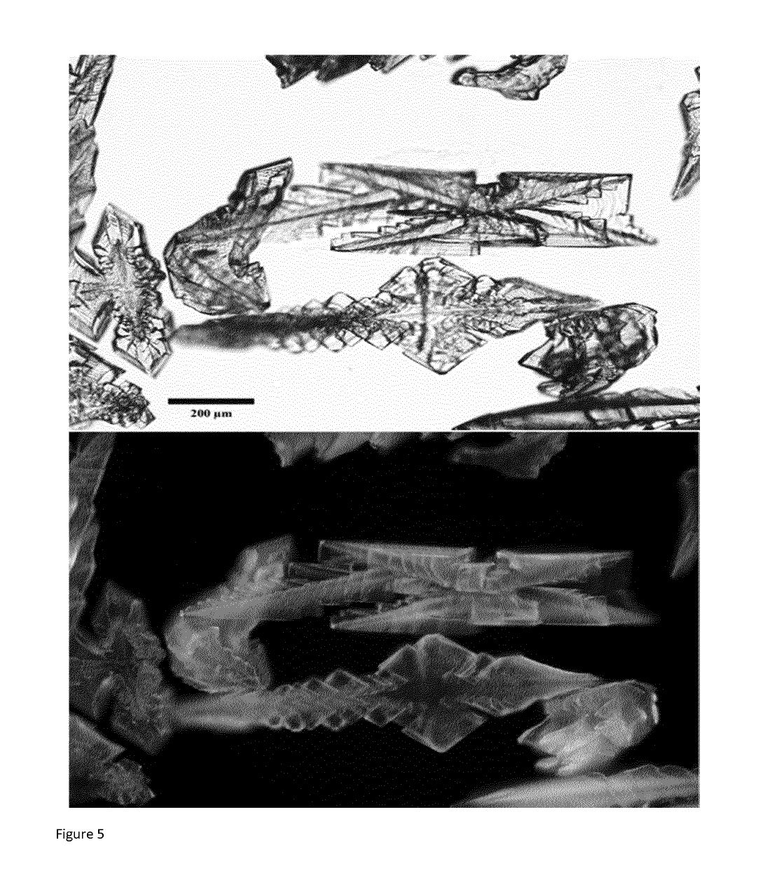

The same set-up and conditions as for Example 1 was applied, but the Reactant 1 was 1 M BaCl₂ and Reactant 2 was made up of 1 M Na₂SO₄ with 0.02M 5(6)-carboxyfluorescein. Small crystals of barite were formed containing tracer. The high concentration of Ba and sulfate ions resulted in rapid formation of crystals with feather-like appearance as shown in FIG. 5.

### Example 3

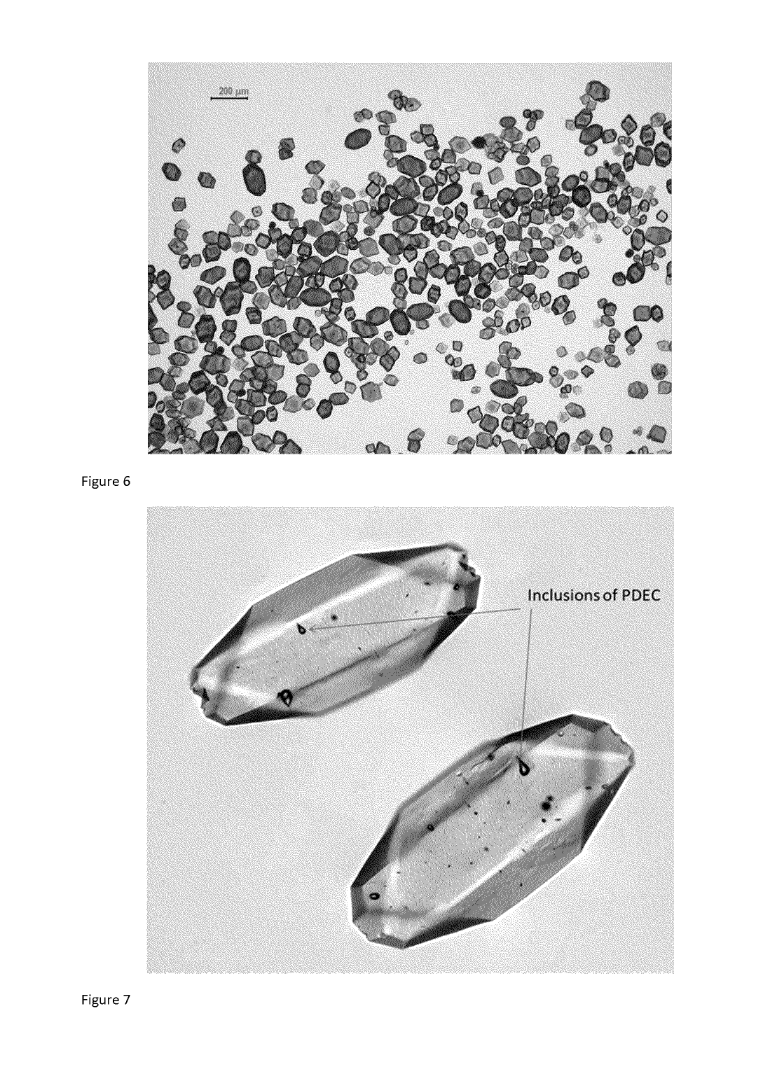

The same set-up as for Example 1 was applied with Reactant 10.5 M CaCl₂ and Reactant 2 0.5 M Na₂CO₃. An Agar Agar gel solution was made containing 2% 5(6)-carboxyfluorescein sodium salt. Undissolved particles of 5(6)-carboxyfluorescein (acid) were also mixed into the gel solution before hardening. The experiment was performed at room temperature (˜24° C.) and stopped after 20 days. The CaCO₃ crystals formed were washed in boiling deionized water and dried at 60° C. They can be seen on FIG. 6. The content of 5(6)-carboxyfluorescein was measured after dissolution of a weighed amount of crystals in diluted HCl and was found to be 2 mg/g.

### Example 4

The same set-up and the same concentrations of SrCl₂ and Na₂SO₄ in Reactant 1 and 2 as in Example 1 were applied. A small volume of the gas tracer perfluorodecaline (PDEC) was homogenized into the silica gel before hardening. PDEC has a boiling point of 142° C. and is an oily liquid insoluble in water. The experiment was performed at a temperature of 30° C. and was stopped after 17 days. After washing and drying the celestite crystals, they were studied in a microscope, see FIG. 7. Small droplets of PDEC had been trapped in the crystals.

### Example 5

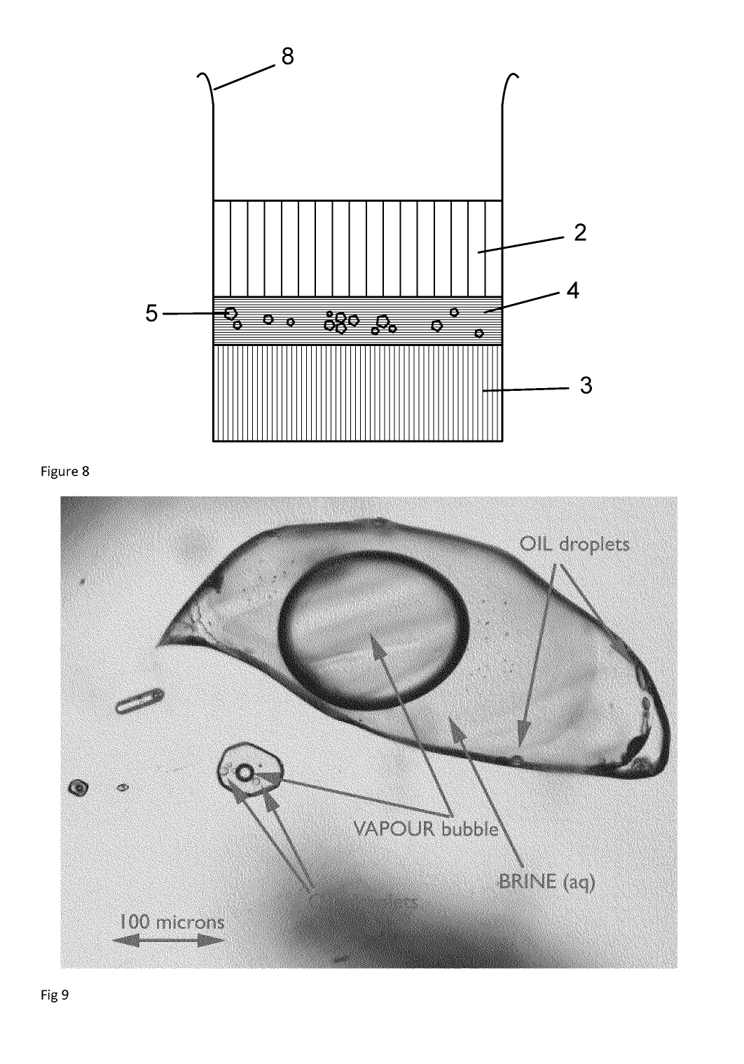

An apparatus suitable for the method of this Example is illustrated schematically in FIG. 8

Into a 250 ml glass beaker 50 ml 1% Agar Agar solution containing 0.5 M CaCl₂ was added and the beaker was cooled to 4° C. for one hour to harden the gel. A 100 ml solution of 1% Agar Agar and 2% 5(6)-carboxyfluorescein sodium salt was prepared and poured on top of the CaCl₂-gel. After hardening another 50 ml 1% Agar Agar solution containing 0.5 M Na₂CO₃ was poured on top of the tracer-gel. After hardening at 4° C. the beaker with the three layers of gel was covered and kept at room temperature for 8 days. Already after one day the crystallization zone was visible. The yield of CaCO₃ crystals with size 100-200 μm was 1.5 g and the mean tracer content was measured to 592 mg/g. See FIG. 8: the crystals (5) appear as white calcite in the central zone (4) containing tracer. This zone is surrounded by zone (2) containing sodium carbonate and zone (3) containing calcium chloride.

1. A controlled-release composition comprising at least one encapsulating compound and at least one tracer and/or oil-field chemical, wherein said encapsulating compound is in the form of synthetic crystals having inclusions, and wherein said tracer and/or oil-field chemical is encapsulated within said inclusions.

2. The controlled-release composition of claim 1 wherein said synthetic crystal are in the form of a mineral sulfate, a mineral carbonate, a mineral halogenide, mineral silicate, a mineral sulfide, mineral molybdate, mineral tungstate (wolframate) a mineral phosphate or a mineral oxide or hydroxide.

3. The controlled-release composition of claim 1 wherein the at least one encapsulating compound has a hardness of 2 or greater on Mohs scale.

4. The controlled-release composition of claim 1 wherein the at least one encapsulating compound has no phase transitions within the Pressure-Temperature field of use (e.g. 1 to 1000 Bar pressure and 20 to 500° C.), preferably 50-350 Bar and 70 to 250° C.

5. The controlled-release composition of claim 1 wherein the at least one encapsulating compound has and a density >2 g/cm³.

6. The controlled-release composition of claim 1 wherein the at least one encapsulating compound is selected from low solubility mineral salts and mixtures thereof (e.g., in the range 10-1 to 10-8 g/100 ml H₂O).

7. The controlled-release composition of claim 1 wherein the at least one encapsulating compound is selected from salts that are normally present in formation water, such as sulphates, carbonates and phosphates, particularly of Ca, Mg, Ba, Sr, Pb, Ag, Zn (e.g. BaSO₄, and/or CaCO₃).

8. The controlled-release composition of claim 1 wherein the at least one encapsulating compound is at least one compound having at least one cation selected from calcium, barium, strontium, lead, silver, magnesium, manganese, iron, titanium, zinc and aluminium and an anion selected from sulphates, halogenides, silicates, molybdates, tungstates, phosphates, carbonates, sulphides, hydroxides and oxides.

9. The controlled-release composition of claim 1 wherein the at least one encapsulating compound is at least one Ba, Sr salt or mixed Ba/Sr salt, or mixtures thereof (e.g. BaSO₄ and SrSO₄, (Ba,Sr)SO₄ or (Ba,Sr)CO₃).

10. (canceled)

11. The controlled-release composition of claim 1 wherein the oil-field chemical is at least one chemical that is added in order to improve performance of the production in a petroleum reservoir or reduce unwanted reactions or precipitations.

12. (canceled)

13. The controlled-release composition of claim 1 wherein the crystals are consolidated into rods or bars.

14. A method for tracking the flow, pH and/or salinity of at least one fluid within a geothermal reservoir or a reservoir for petroleum production, said method comprising applying at least one controlled-release composition as defined in any preceding claim to at least one known position in said reservoir and monitoring for the absence, presence and/or concentration of at least one of said tracers in fluid produced from at least one well in said reservoir.

15. The method of claim 14 wherein at least two different controlled-release compositions are applied to said reservoir wherein the two controlled-release compositions comprise different tracers.

16. The method of claim 15 wherein each of the two or more controlled-release compositions are placed at a different location within the reservoir, such as in a different zone and/or different level.

17. (canceled)

18. The method of claim 14 further comprising relating the absence, presence and/or concentration of the tracer or each tracer to the flow of at least one fluid within said reservoir.

19. The method of claim 14 wherein said fluid is at least one of oil, gas and water.

20. The method of claim 14 wherein at least one controlled-release composition is used in a clean-out valve or tracer-release valve.

21. The method as claimed in claim 14 for monitoring fluid flow within a fracture in said reservoir.

22. (canceled)

23. (canceled)

24. (canceled)

25. (canceled)

26. A method for the formation of a controlled-release composition as claimed in claim 1 comprising contacting solutions of a first and second salt in the presence of a diffusion medium containing at least one tracer, wherein upon contact the solutions of said first and second salts precipitate crystals of an encapsulation compound having therein solid or fluid inclusions of said at least one tracer (either as tracer trapped in fluid inclusions and/or as tracer trapped in the mineral crystal structure).

27. (canceled)

28. (canceled)
